(19) United States
(12) Patent Application Publication
(10) Pub. No.: US 2015/0058716 A1
(43) Pub. Date: Feb. 26, 2015

(54) SYSTEM AND METHOD FOR SUMMARIZING DOCUMENTS

(71) Applicant: iPedago, LLC, Canandaigua, NY (US)

(72) Inventors: William Terrence Boothman, Canandaigua, NY (US); Anthony Christopher Barone, Essex Jct., VT (US)

(73) Assignee: iPedago, LLC, Canandaigua, NY (US)

(21) Appl. No.: 13/972,213

(22) Filed: Aug. 21, 2013

(51) Int. Cl. G06F 17/21; G06F 17/27

(52) U.S. Cl. CPC G06F 17/211; G06F 17/2705
USPC 715/254

(57) ABSTRACT

A computer based system and method for exporting user-selected text by allowing a user to select a plurality of text segments, selecting from a block of text, flagging each of the text segments from a plurality of text segments such that each of text segments may be retrieved later, retrieving the plurality of text segments, and then exporting the plurality of text segments as data that may be read by a software application. The selected text segments may also be assigned one or more indicia for categorizing and sorting according to user-defined criteria.

### FIELD OF THE DISCLOSURE

The present disclosure relates to summarizing a document, and more particularly to methods and systems for displaying a summary of a document and exporting the summary in a format that may be modified by a user.

### BACKGROUND

Text files are used by students and professionals alike, to review documents, collect sources, and take notes, along with endless other applications. Both professionals and students often require the ability to bring together many different passages of these text files in an effort to summarize the document. While the ability to copy and paste from these text files has been known in the art, this has been largely limited to copying and pasting a single passage of text at a time, which is inefficient for summarizing a document. Further, any systems that have allowed for the summarizing of multiple passages, have not provided an ability to filter, search, or export the summary in a format that may user may manipulate and modify. Accordingly, there is a need in the art for a system that allows a user to summarize a document, to filter according to multiple criteria (such as priority and assigned categories), to search the summary, and to export the summary in a format that a user may manipulate and modify.

### BRIEF SUMMARY

The present invention, according to an aspect, is directed to a method of exporting user-selected text, comprising the steps of receiving from a user a selection of a plurality of text segments, selected from a block of text; flagging each of the text segments from a plurality of text segments such that each of text segments may be retrieved later; retrieving the plurality of text segments; and exporting the plurality of text segments as data that may be read by a software application.

According to a further aspect of the present invention, an embodiment of the present invention further comprises the step of receiving from a user at least one identifier to be associated with least one text segment within the plurality of text segments; and associating the identifier with the at least one text segment.

According to another aspect of the present invention, an embodiment of the present invention further comprises the steps of receiving from a user a command to filter the plurality of text segments by the identifier; and filtering the plurality of text segments by the identifier according to the command.

According to another aspect, the command is a search term.

According to another aspect, the flagging further comprises the step of wrapping each of the text segments from the selection of a plurality of text segments in an HTML tag.

According to another aspect, an embodiment of the present invention comprises the steps of receiving the block of text; parsing the block of text for the HTML tag; parsing the HTML tag to obtain each of the text segments from the plurality of text segments; and adding each of the obtained text segments to a list to be accessed later.

According to another aspect, the identifier is a priority.

According to another aspect, the identifier is a user-determined tag.

According to another aspect, an embodiment of the present invention further comprises the step of displaying the text segments in a user-interface.

According to another aspect, the software application is a word processor.

According to another aspect of the present invention, an embodiment of the invention comprises a computerized system for the exporting of user selected, comprising, an input module configured to receive from a user a selection of a plurality of text segments, selected from a block of text; a marking module configured to flag each of the text segments from a plurality of text segments such that each of text segments may be retrieved later; an aggregating module configured to retrieve the plurality of text segments; and an export module configured to export the plurality of text segments as data that may be read by a software application.

According to another aspect, the input module is configured to receive from a user at least one identifier to be associated with least one text segment within the plurality of text segments; and the marking module is configured to associate the identifier with the at least one text segment.

According to another aspect, the input module is further configured to receive from a user a command to filter the plurality of text segments by the identifier; and aggregating module is further configured to filter the plurality of text segments by the identifier according to the command.

According to another aspect, the command is a search term.

According to another aspect, the marking module is configured to flag by wrapping each of the text segments from the selection of a plurality of text in an HTML tag.

According to another aspect, the aggregating module is further configured to receive the block of text; parse the block of text for the HTML tag; parse the HTML tag to obtain each of the text from segments form the plurality of text segments; and add each of the obtained text segments to a list to accessed later.

According to another aspect, the identifier is a priority.

According to another aspect, the identifier is a user-determined tag.

According to another aspect, the displaying module for displaying the text segments in a user-interface.

According to another aspect, the software application is a word processor.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a screenshot of an embodiment of the front end of the present invention.

FIG. 2 is a screenshot of an embodiment of the front end of the present invention.

FIG. 3 is a screenshot of an embodiment of the front end of the present invention.

FIG. 4 is a screenshot of an embodiment of the front end of the present invention.

FIG. 5 is a screenshot of an embodiment of the front end of the present invention.

FIG. 6 is a screenshot of an embodiment of the front end of the present invention.

FIG. 7 is a screenshot of an embodiment of the front end of the present invention.

FIG. 8 is a screenshot of an embodiment of the front end of the present invention.

FIG. 9 is a screenshot of an embodiment of the front end of the present invention.

FIG. 10 is a high level flowchart of an embodiment of the back end of the present invention.

FIG. 11 is a flowchart of an embodiment of a marking module according to the present invention.

FIG. 12 is a flowchart of an embodiment of an aggregating module according to the present invention.

FIG. 13. is a flowchart of an embodiment of an displaying module according to the present invention.

FIG. 14. is a flowchart of an embodiment of an exporting module according to the present invention.

### DETAILED DESCRIPTION

According to one embodiment, the present invention is a software application for that summarizes a user's highlights within a body of text, allows the user to manipulate the results, and exports the summary in a format which may then be further modified by the user. The software application may be implemented as a dynamic web-application, using JavaScript and AJAX to respond user-commands and update the browser. However the invention may also be embodied as a local application, or web application using any other method known in the art. Alternatively, the invention may be embodied as a mobile application on smartphones, e-readers, tablets, or any other computing device now known or later known in the art.

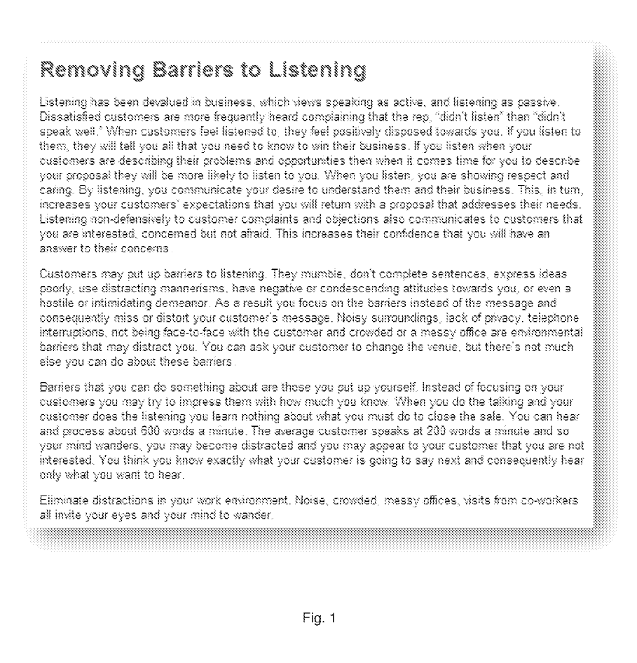

Referring now to the drawings, wherein like reference numerals refer to like parts throughout, there is seen in FIG. 1 an embodiment of the front end of the present invention. FIG. 1 shows an example of text that has been imported into the embodiment of the present invention. The text may be any length and may be imported from any source (website, Word document, PDF, etc.). In one embodiment, a dialogue box is provided to allow a user to select a file to import from a local or remote source.

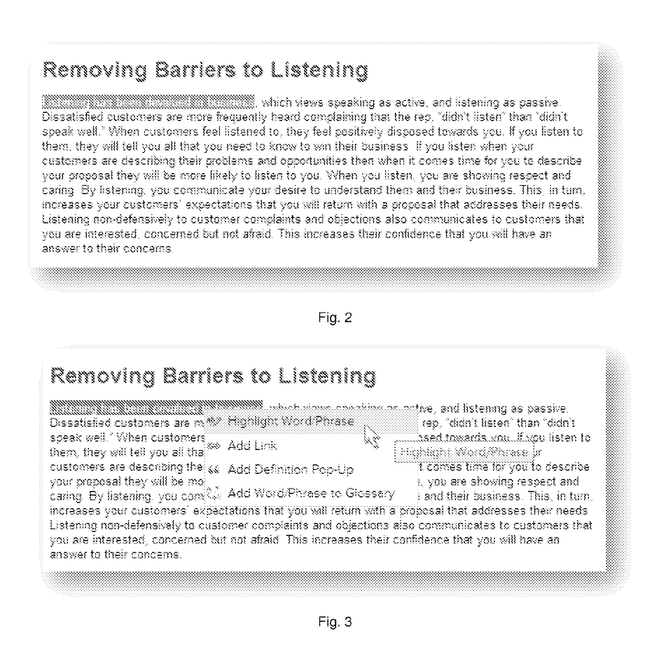

Once the text is imported, as shown in FIG. 2, the user may select multiple portions of the text to highlight, by using a cursor or any other method for selecting text known in the art. As shown in FIG. 3, having selected a portion of text, the user may right-click on the selected text and elect to highlight the word or selected phrase. In an alternative embodiment, the selected text is highlighted automatically, or the user is provided with an option to automatically highlight the selected text, without any further action.

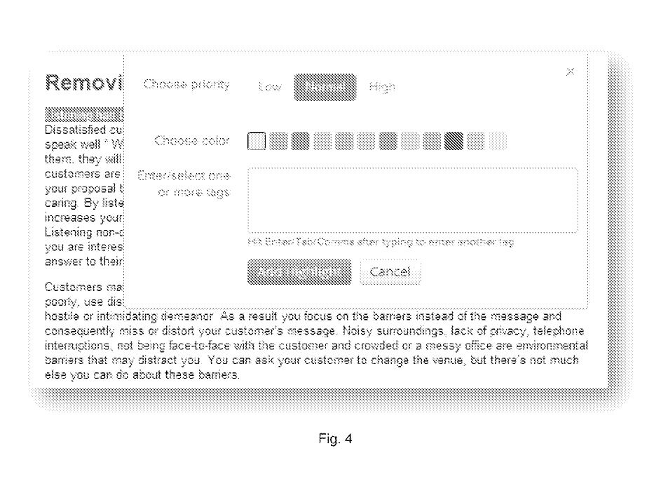

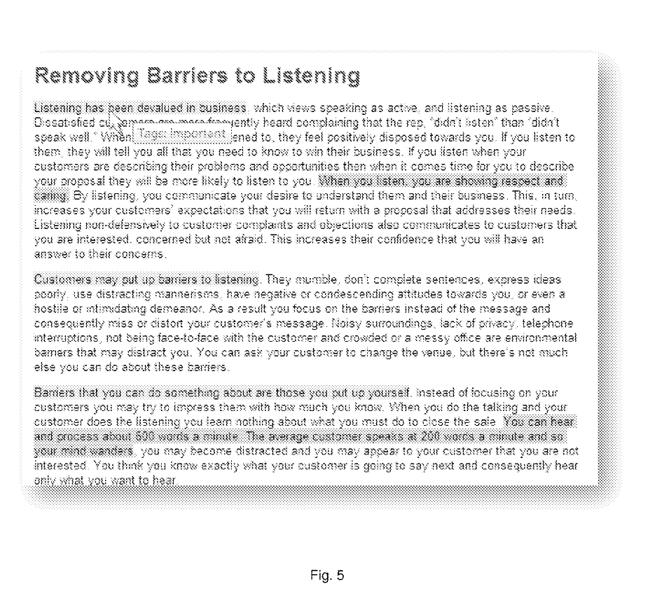

According to a preferred embodiment, as shown in FIG. 4, once the selected text is highlighted, the user may choose any highlight color (12 in the present embodiment) and at least one secondary identifier. In the preferred embodiment, the secondary identifier is a user selectable “priority,” which may be marked as “low,” “normal,” or “high.” In the preferred embodiment, the default priority is “normal.” Another secondary identifier may be a “tag” that would allow the user to create and customize an identifier for a particular highlight, or for multiple highlights. In the preferred embodiment, as shown in FIG. 5, any tag associated with a highlight may appear as a mouse-over text pop-up. Alternatively, the tag may be displayed in the margins, or alongside the highlighted text.

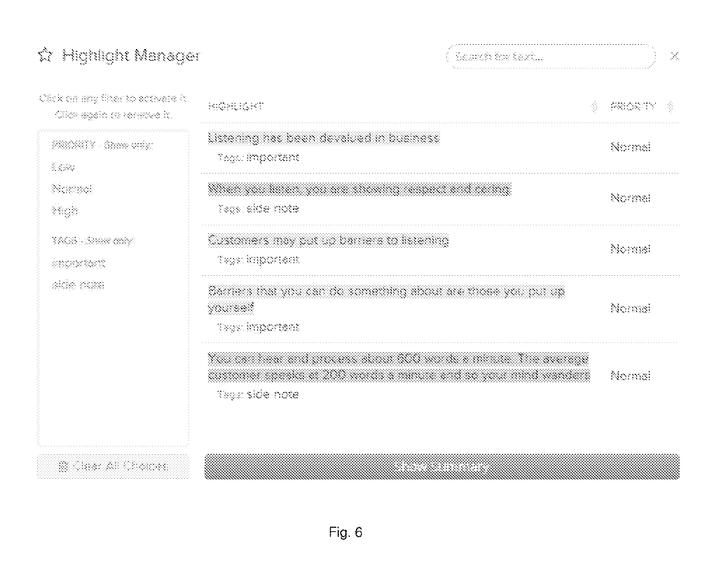

As shown in FIG. 6, according to the preferred embodiment, all highlights and secondary identifiers may be aggregated and displayed in a highlight manager. In an alternative embodiment, the highlight manager may also display all secondary identifiers. In yet another embodiment, the highlight manager may display the highlighted text and/or secondary identifiers in a side-by-side pane that updates automatically as the user highlights, or when the user elects to show all highlights.

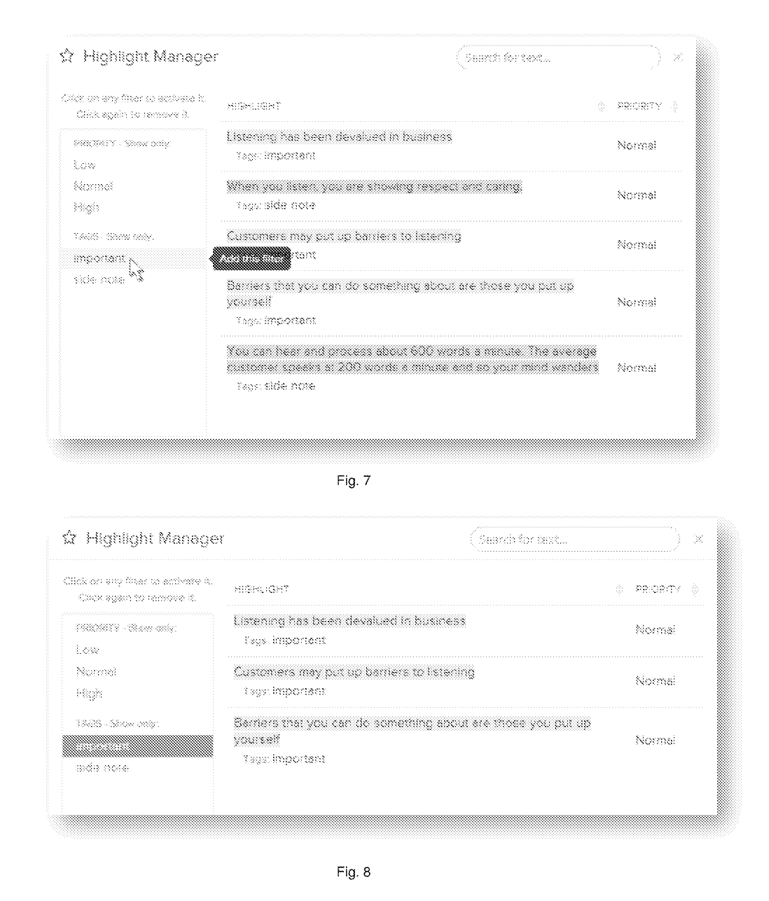

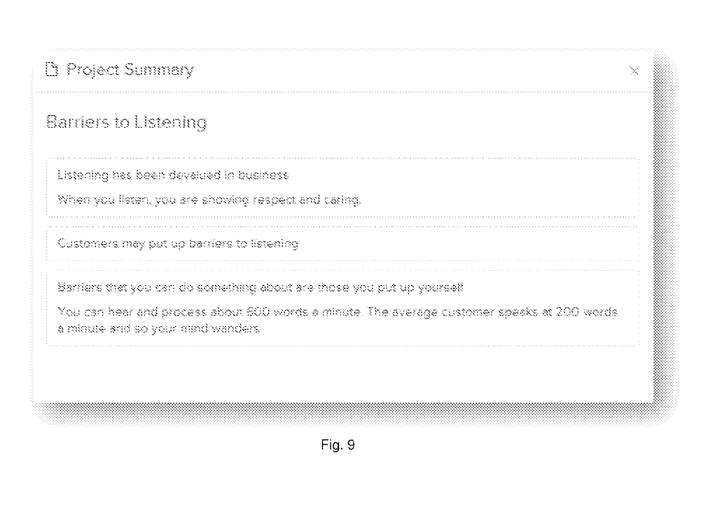

In the preferred embodiment, through the highlight manager, the user may elect to filter their highlights according to the secondary identifiers. For example, FIG. 7 shows an embodiment of the present invention with the user preparing to “show only” the important tag with highlight manager. Selecting this option, as shown in FIG. 8, would filter all claims except those bearing the important tag. In an alternative embodiment, the user may filter all highlights via a sidebar, or a search bar located in the toolbar. The user may filter according to multiple priorities and multiple tags at once. For example, a user may select to show all “normal” and “high” priority highlights as well as all highlights marked by the tag “important.” Filters may be added or removed at will. In the preferred embodiment, the user may summarize the highlights shown in the highlight manager. As shown in FIG. 9, electing to summarize will produce a summary containing all highlights, and in one embodiment, all secondary identifiers. If the user has selected any filters, only those highlights not filtered will appear in the summary. Alternatively, the user may elect to summarize without filtering or using the highlight manager.

The user may create a PDF of the summary, export as a Word document, e-mail, or save it either locally or to a remote server. The user may also print the summary page. Alternatively, if the user has filtered according to any secondary identifier, the user may export or print only those highlights remaining after filtering. The user may also save different versions of the same text, containing different highlights, secondary identifiers, or filters.

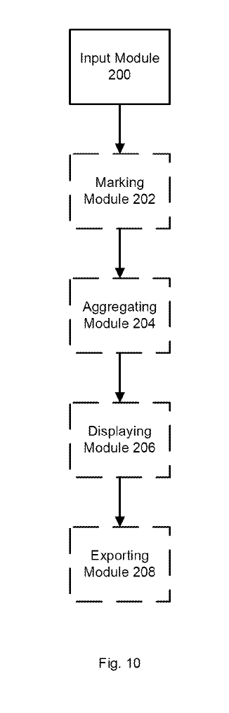

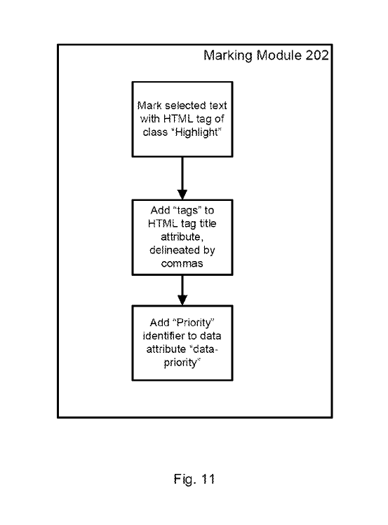

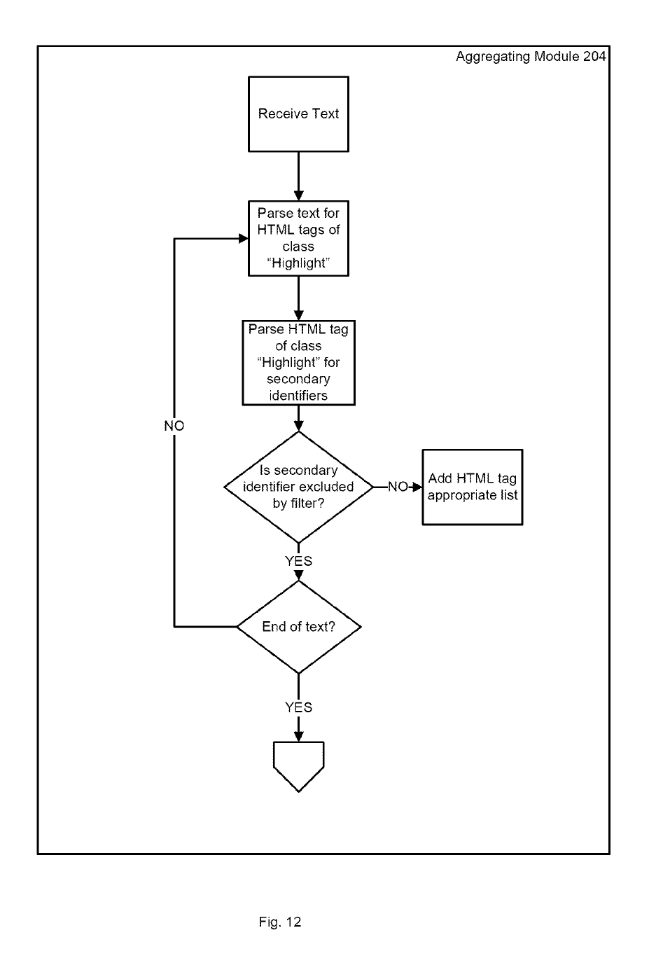

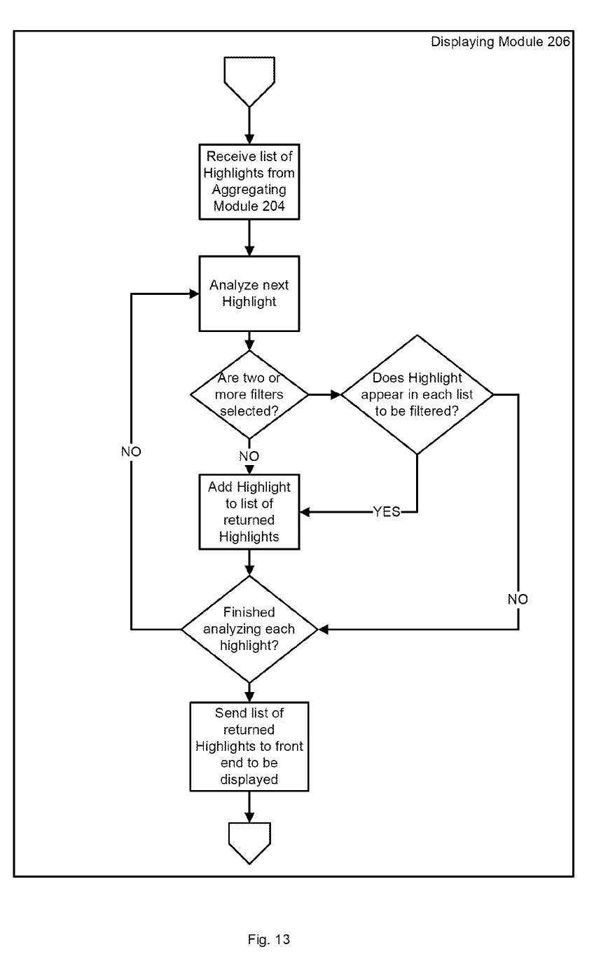

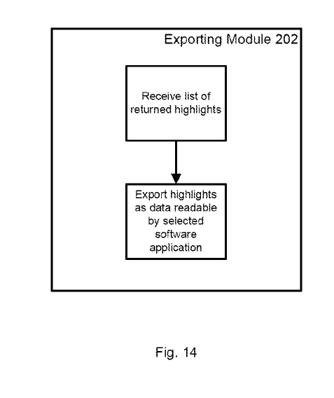

Focusing now on the back end, as shown in FIG. 10, according to one embodiment, comprises an input module 200, a marking module 202, aggregating module 204, a displaying module 206, and an exporting module 208. In the first step, input module 200 receives an input from a user of any highlights and any secondary identifiers. This text is either stored on a remote server or locally. Next, marking module 202 marks the selected text with a flag to be stored for later access. In the preferred embodiment, marking module 202 may mark the selected text by wrapping it in an HTML <span>tag, with the class of highlight. Any secondary identifiers may be placed in attributes of the HTML tag. For example, in the preferred embodiment, tags are placed in the title attribute, delimited by comma separators. Priority identifiers may be placed in a data attribute, “data-priority.” In an alternative embodiment, marking module 202 may “flag” the highlighted text and secondary identifiers by storing them in separate arrays. For example, each new tag identifier may be stored in a separate array. Alternatively, the selected text and secondary identifiers may be stored according to any method known in the art. In either embodiment, the marked text may be stored locally or on a remote server.

According to one embodiment, the next broad step is to display the highlighted text. In the preferred embodiment, aggregating module 204 receives all text, including the marked text from the prior step, in the order arranged in the front end. In the preferred embodiment, aggregating module 204 makes an AJAX call to a server to return all text. Next, aggregating module 204 loops through the received text and looks for all HTML <span> tags with the class of highlight. Having found an HTML <span> tag with class of highlight, aggregating module 204 next cross-references the secondary identifiers with the filters the user has applied. If highlight bears any of the secondary identifiers from the filter, the aggregating module 204 adds the highlight to the appropriate list. For example, a user selects the “high” priority filter. Aggregating module 204 parses the highlight for data attribute “data-priority” and finds the highlight has the priority “high.” Because the user has selected the “high” priority filter, the highlight is added to in the “priority filter list”. If the user has also selected the “important” tag filter, aggregating module 204 would next parse title attribute according to commas. If the title attribute contained the “important” tag, the highlight would be added to the tag filter list. Alternatively, if arrays are used instead of HTML tags, aggregating module 204 calls any arrays used to store highlights or secondary identifiers.

Next, according to one embodiment, displaying module 206 returns each highlight found in one of the lists (from the prior step) to the front of end to be displayed. If two filters are selected, displaying module 206 checks each highlight against both filter lists to ensure that the highlight is present in both. If the highlight is not present in both, the highlight is not displayed. In the preferred embodiment, all highlights that appear within the same paragraph are grouped together so that they may later be displayed within the same text box. In the preferred embodiment, the highlights are displayed within the summary view.

Next, according to one embodiment, exporting module 208 exports each highlight found in one of the lists as data readable by a computer application. If two filters are selected, exporting module 208 checks both filter lists to ensure that the highlight is present in both. Exporting module 208 can export the data as readable by a word processor, such as Microsoft Word, as a portable data file, as an e-mail, or other similar mediums that allow a user to manipulate the output of exporting module 208. In an alternative embodiment, exporting module 208 receives the list of highlights to export from display module 206 instead of selecting them from the lists individually.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the examples is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

Although the present invention has been described in connection with a preferred embodiment, it should be understood that modifications, alterations, and additions can be made to the invention without departing from the scope of the invention as defined by the claims.

What is claimed is:

1. A method of exporting user-selected text, comprising the steps of:
receiving from a user a selection of a plurality of text segments, selected from a block of text;
flagging each of said text segments from a plurality of text segments such that each of text segments may be retrieved later;
retrieving said plurality of text segments; and
exporting said plurality of text segments as data that may be read by a software application.

2. The method of claim 1, further comprising the steps of:
receiving from a user at least one identifier to be associated with least one text segment within said plurality of text segments; and
associating said identifier with said at least one text segment.

3. The method of claim 2, further comprising the steps of:
receiving from a user a command to filter said plurality of text segments by said identifier; and
filtering said plurality of text segments by said identifier according to said command.

4. The method of claim 3, wherein the command is a search term.

5. The method of claim 1, wherein flagging further comprises the step of wrapping each of said text segments from said selection of a plurality of text segments in an HTML tag.

6. The method of claim 5, wherein the step of retrieving comprises the steps of:
receiving said block of text;
parsing said block of text for said HTML tag;
parsing said HTML tag to obtain each of said text segments from said plurality of text segments; and
adding each of said obtained text segments to a list to be accessed later.

7. The method of claim 2, wherein said identifier is a priority.

8. The method of claim 2, wherein said identifier is a user-determined tag.

9. The method of claim 1, further comprising the step of displaying said text segments in a user-interface.

10. The method of claim 1, wherein said software application is a word processor.

11. A computerized system for the exporting of user selected, comprising:
an input module configured to receive from a user a selection of a plurality of text segments, selected from a block of text;
a marking module configured to flag each of said text segments from a plurality of text segments such that each of text segments may be retrieved later;
an aggregating module configured to retrieve said plurality of text segments; and
an export module configured to export said plurality of text segments as data that may be read by a software application.

12. The system of claim 11, wherein said input module is configured to receive from a user at least one identifier to be associated with least one text segment within said plurality of text segments; and said marking module is configured to
associate said identifier with said at least one text segment.

13. The system of claim 12, wherein said input module is further configured to receive from a user a command to filter said plurality of text segments by said identifier; and aggregating module is further configured to filter said plurality of text segments by said identifier according to said command.

14. The system of claim 13, wherein the command is a search term.

15. The system of claim 11, wherein said marking module is configured to flag by wrapping each of said text segments from said selection of a plurality of text in an HTML tag.

16. The system of claim 15, wherein said aggregating module is further configured to receive said block of text; parse said block of text for said HTML tag; parse said HTML tag to obtain each of said text from segments from said plurality of text segments; and add each of said obtained text segments to a list to accessed later.

17. The system of claim 12, wherein the said identifier is a priority.

18. The system of claim 12, wherein said identifier is a user-determined tag.

19. The system of claim 11, further comprising a displaying module for displaying said text segments in a user-interface.

20. The system of claim 11, wherein said software application is a word processor.
